(19) United States
(12) Patent Application Publication
(10) Pub. No.: US 2026/0202005 A1
(43) Pub. Date: Jul. 16, 2026

(54) POOL LADDER ANCHOR BRACKET

(71) Applicant: Donald Wayne BEECHLER, Greenwood, IN (US)

(72) Inventor: Donald Wayne BEECHLER, Greenwood, IN (US)

(21) Appl. No.: 19/449,406

(22) Filed: Jan. 14, 2026

Related U.S. Application Data
(60) Provisional application No. 63/745,313, filed on Jan. 14, 2025.

(51) Int. Cl. F16M 13/02; E04H 4/14; F16B 9/00

(52) U.S. Cl. CPC F16M 13/02; E04H 4/144; F16B 9/00

(57) ABSTRACT

A pool ladder anchor bracket is described for use with pools that have an automatic pool cover which prevents pool steps from being connected to the handrailing. The bracket allows the handrailing to be properly aligned to the steps without the need for careful measurement and construction. The bracket is installed on the back of the wall panel. The bracket can be aligned with the steps as it is secured to the back of the wall panel. The bracket included sockets into which the handrails are inserted. So long as the bracket is properly installed the handrails will be perfectly aligned with the pool steps.

### BACKGROUND

Many in-ground pools feature a “deep end” with long vertical walls. Typically the deep end features a ladder with steps installed in the pool wall. The ladder has handrails that lead continually up to the top of the latter that help the swimmer exit the pool.

In some versions, rather than attaching a ladder to the pool wall, the steps can be molded into the pool wall, typically a side panel will be specially formed to include these steps. In this version, to ensure that the steps and handrails are properly aligned, the handrails are directly connected to the upper portion of the panel.

More recently, pool covers have been designed that can be deployed automatically. These covers extend at the water line from one end of the pool to the other end and cover the entire surface. Thus, the pool cover would hit the handrail as it passes that portion of the pool above the steps. As a result, the handrail cannot be directly connected to the side panel but must be installed separately on the ground outside of the pool.

Unfortunately, this makes it difficult to properly align the handrail. It must be directly above the steps. In southern locations, where the ground does not freeze in the winter, pool walls can be formed out of concrete. If the steps are formed in the walls, the handrails can be placed directly over the steps.

But in northern climes concrete walls are not practical. In-ground pool walls are formed with panels and pool liners. The walls of the in-ground pool are assembled first. The handrails cannot be installed at that time. When the side panels are used, the in-ground pool is excavated to include an “over dig.” For example, a 20 ft by 40 ft pool would typically have three extra feet of earth excavated so the hole would measure 26 ft by 46 ft. The handrails could not be installed until the over dig area was refilled.

The handrails would then be installed on top of the refilled area when the concrete deck surrounding the pool is poured. The handrail location would then be precisely and accurately predicted so that when the cement is poured the handrails are exactly above the steps. Furthermore, care just be taken that the handrails are not jostled and moved during the final stages of construction. In that case the handrails may be misaligned even if the initial measurements were accurate.

The present invention solves this problem. The steps can be perfectly aligned with the handrails with a minimum of skill and effort even though the space between the steps and railing must be clear so that the pool cover can pass through.

### SUMMARY

A typical inground pool is made with a liner, especially in northern climates. The steps in a typical inground pool come preformed in a panel that is installed between flanking panels that make up the pool walls. In the current invention, a bracket is attached to the back of the panels, near the top. The bracket contains sockets into which the handrails will be installed. Together, these components will automatically align the steps with the ladder grab rails and there will be a space between the steps and handrail for the automatic cover to pass.

### BRIEF DESCRIPTION OF THE DRAWINGS

FIG. 1 is a pool wall panel with pre-formed steps 100.

FIG. 2 illustrates the bracket installed on the pool panel containing the steps.

FIG. 3 is a view of the finished pool with handrails.

FIGS. 4A-D are line drawings of the various bracket components.

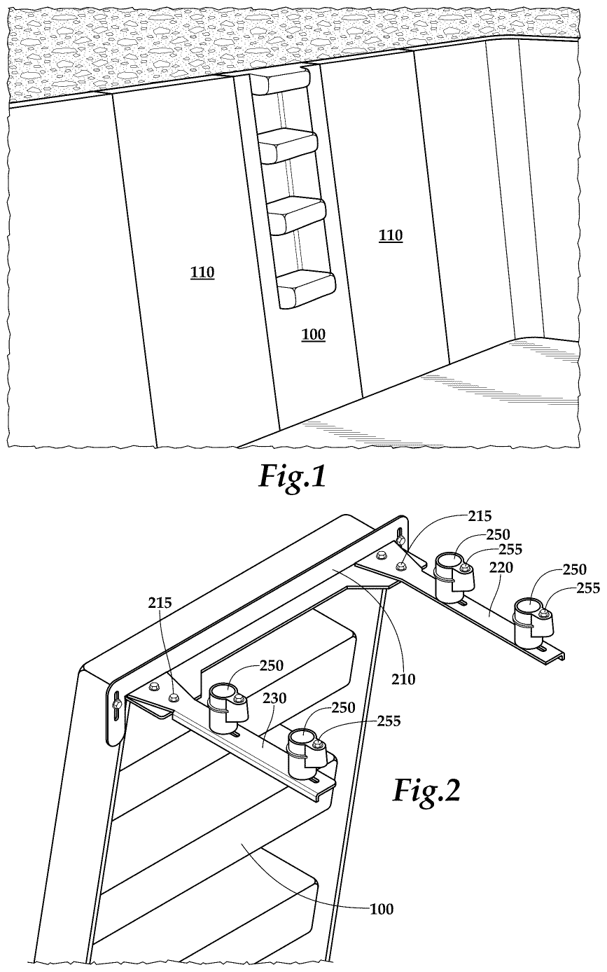

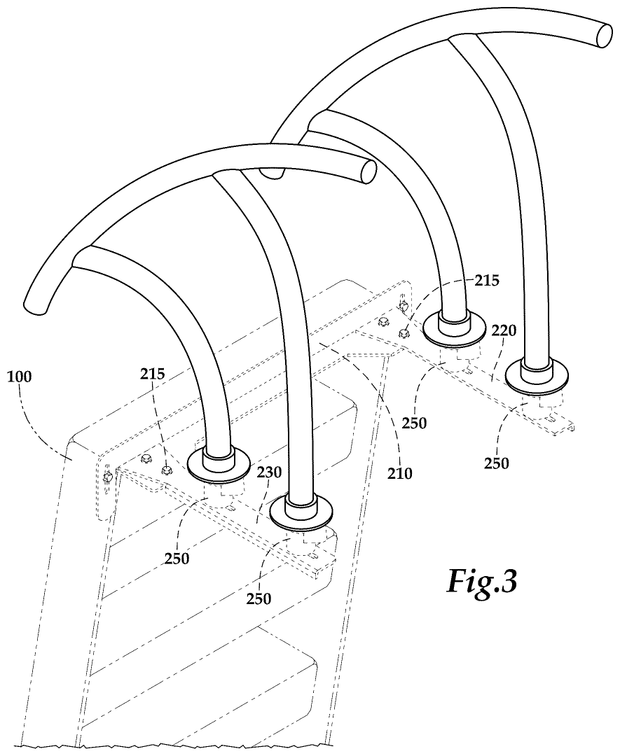

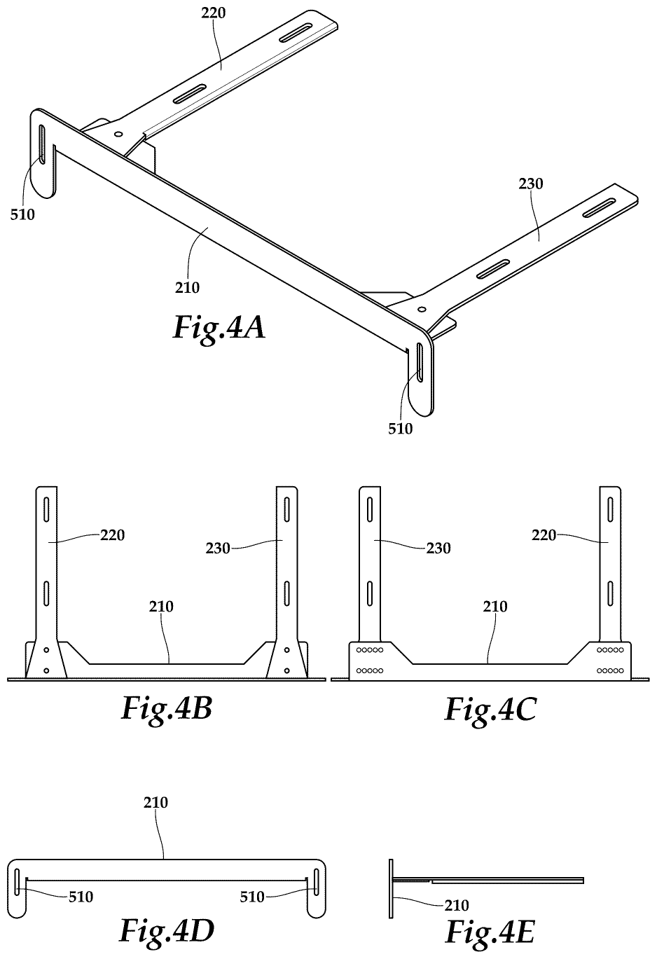

### DETAILED DESCRIPTION

The invention is installed as follows. Following excavation, the pool wall panels are installed. The panel containing the steps would be installed between two normal wall panels.

Next, in a preferred embodiments, the pool anchor bracket is three components: rail anchor arms (right 220 and left 230) and a face plate 210. The two pool anchor bracket are located on either side of the face plate 210. Alternatively, all three portions can be provided in a single piece. The three components can either be attached together, or the face plate 210 can be installed first, then the two arms 220, 230 can be attached to the installed face plate.

The face plate is installed on the back of the wall panel. Care is taken to properly align the face plate relative to the steps in the wall panels. The middle of the face plate should be in the middle of the steps 100.

The face plate is then secured to the back of the wall panels. Typically, holes 510 are provided in the face plate 210. These face plate holes 510 are used to mark corresponding locations in the wall panels, near the tops of the wall panels. Next, holes are drilled in the wall panels. The face plate 210 is typically attached to the wall panels using bolts and nuts. Any standard attachment mechanism, however, can be used including rivets, screws and the like.

The face plate is typically attached to the panel containing the steps 100. In another embodiment, the face plate is longer than the panel containing the steps and extends to the two panels 110 that flank the panel containing the steps. In this embodiment the face plate is attached to the flanking panels 110. The only critical feature is that the middle of the face plate must be aligned with the middle of the steps.

If the two arms 220, 230 are not already attached, they are attached next. Each arm included a socket 250 that will anchor the base of the handrail. In a preferred embodiment the arms are pivotable 215 so that the angle with the face plate can be adjusted. Also the height of the sockets are also adjustable 255 in a preferred embodiment. This allows for the sockets on the right and left side of the face plate to be adjusted until they are perfectly level with respect to each other.

When the angles and heights are aligned and adjusted, the various components are secured in place. If bolts are used the bolts are tightened.

The construction can now continue. The over dig can be back filled. Typically a non-compressible material is used, such as rock or gravel.

Now the area around pool is completed, typically by pouring cement. In a typical embodiment the top of the cement is flush with the top of the anchor sockets. In alternative embodiments the top of the sockets can be slightly below the level of the surface of the cement or slightly above.

The handrails or grab rails 410 can now be inserted into their sockets 250 and secured.

By following these instructions, the rails will be at a proper level, plumb and secure and perfectly aligned with the steps.

What is claimed is:

1. A pool ladder anchor bracket, suitable for aligning handrailing with pool
steps, comprising: a face plate, a left anchor socket arm and a right anchor socket arm,
the face plate further comprising a plurality of holes for attaching the face plate to the back side of pool wall panels so that the center of the face plate is at the center of steps formed in the wall panel front,
the left arm anchor socket arm extending generally perpendicularly from the left side of the face plate and further comprising one or more handrail sockets,
the right anchor arm extending generally perpendicularly from the right side of the face plate and further comprising one or more handrail sockets, and
wherein the installed pool ladder anchor bracket has sockets for inserting handrailing which are perfectly aligned on either side of the pool steps and when the handrailing is installed, results in handrailing being perfectly aligned with the pool steps.

2. The pool ladder anchor bracket as defined in claim 1 wherein the face plate is attached to the pool wall panel containing the steps.

3. The pool ladder anchor bracket as defined in claim 1 wherein the face plate is attached to the wall panels on either side of the panel containing the steps.

4. The pool ladder anchor bracket as defined in claim 1 wherein the right and left anchor socket arms can pivot relative to the face plate and be adjusted as needed before being locked down.

5. The pool ladder anchor bracket as defined in claim 1 wherein, after the pool ladder anchor bracket is attached to the pool wall panels, the heights of the sockets can be adjusted as needed to ensure the sockets are at the proper height relative to each other.

6. The pool ladder anchor bracket as defined in claim 1 wherein the handrails are grab rails.

7. A method of assembly of a pool handrails so that handrails are aligned
with pool steps comprising the use of the pool ladder anchor bracket of claim 1, wherein the method comprises the following steps:
installing a pool handrail face plate on the back of a pool wall panel so that the middle of the bracket is in the middle of pool steps molded into the wall panel inserting pool handrails into anchor bracket sockets.
